(19) United States
(12) Patent Application Publication
(10) Pub. No.: US 2008/0109291 A1
(43) Pub. Date: May 8, 2008

(54) Executing and Tracking Strategic Plans

(75) Inventor: Martha Montes de Oca, Miami, FL (US)

Correspondence Address: HOLLAND & KNIGHT LLP, 633 WEST FIFTH STREET, TWENTY-FIRST FLOOR, LOS ANGELES, CA, 90071-2040, US

(73) Assignee: MONTES DE OCA GROUP, INC., Miami, FL (US)

(21) Appl. No.: 11/557,198

(22) Filed: Nov. 7, 2006

(51) Int. Cl. G06F 15/02

(52) U.S. Cl. 705/9

(57) ABSTRACT

A method for generating and tracking a strategic plan is disclosed. The method includes generating a plurality of assignments necessary for achieving a strategic plan for a business association, wherein each assignment is associated with at least one user of said strategic plan and presented to such a user or users. The method further includes collecting data pertaining to the strategic plan, analyzing the data collected and generating customized reports regarding the progress of said strategic plan.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of strategic and business planning, and more particularly relates to the field of implementing and updating strategic plans through information systems that can be easily tracked and measured.

### BACKGROUND OF THE INVENTION

A strategic plan may be described as a summary of how a business owner, manager, or entrepreneur intends to organize an entrepreneurial endeavor and implement activities necessary and sufficient for the venture to succeed. Business plans may be used internally for management and planning, and may also be used to convince outsiders such as banks or venture capitalists to invest money into a venture. There are various ways to execute and track a strategic plan. In a typical scenario, business executives review the strategic plan, pull out and make photocopies of what pertains to them, and provide copies to their subordinates for them to execute. The subordinates are usually directors and managers who are entrusted with the implementation of the portion of the strategic plan that pertains to their particular department. If time permits, the subordinates may develop mechanisms to keep track of their responsibilities. Many use project management software, such as Microsoft Project, to manage and track their projects. This type of software, however, is not tied to a centralized system where senior management is able to view the progress of the implementation of each portion of the strategic plan.

The aforementioned has some drawbacks. Strategic plans are usually expensive to develop. Companies usually hire experts, such as consultants in the areas of strategic planning and business development, to generate a strategic plan. These consultants take the executive team and boards or stakeholders through a variety of exercises, interviews, Strengths-Weaknesses-Opportunities-Threats (SWOT) analysis, market research, and other exercises in order to develop a strategic plan for the company. The strategic plan of a hospital, for example, might have over fifteen initiatives for meeting the hospital's goals.

Problems tracking the strategic plan often begin because executives may fail to consider all of the elements necessary to fully execute the strategic plan. The strategic plan may not be broken down into measurable goals and objectives. Also, managers may not be provided with clear assignments, including dates of expected completion. Additionally, the entire strategic plan may not be communicated and understood by everyone involved. Indicators or success factors are often not created and recorded throughout the implementation of the strategic plan for future decisions to be made in a timely manner if the initiative is not working. Lastly, employees may not be held accountable for implementing the part of the strategic plan for which they are responsible.

As a result, a strategic plan sometimes ends up as a book on a bookcase collecting dust and, worse yet, the expectations of boards of directors and stakeholders may not be met. Therefore, strategic plans sometimes do not appear to have succeeded because someone did not follow through on an assignment, or a critical piece was not realized during development of the strategic plan.

Therefore, a need exists to overcome the problems with the prior art as discussed above, and particularly for a way to optimize the process of generating and tracking strategic plans.

### SUMMARY OF THE INVENTION

Briefly, according to an embodiment of the present invention, a method for generating and tracking assignments related to implementing a strategic plan is disclosed. The method includes generating a plurality of assignments necessary for achieving the strategic plan for a business association, wherein each assignment is associated with at least one user of the strategic plan and presented to such user or users. The method further includes collecting data pertaining to a strategic plan, analyzing the data collected, and generating customized reports regarding the progress of the strategic plan.

According to another embodiment of the present invention, an information processing system for generating and tracking a strategic plan is disclosed. The information processing system comprises a plurality of assignments necessary for achieving the strategic plan for a business entity, wherein each assignment is associated with at least one user of the strategic plan. The system comprises a first interface for presenting the plurality of assignments to users of the strategic plan and a second interface for collecting data pertaining to the strategic plan. The information processing system further comprises a computer system configured for analyzing the data collected and generating customized reports regarding the progress of the strategic plan.

According to another embodiment of the present invention, a computer readable medium including computer instructions for generating and tracking a strategic plan is disclosed. The computer readable medium includes computer instructions for generating a plurality of assignments necessary for achieving the strategic plan for a business association, wherein each assignment is associated with at least one user of the strategic plan and presented to such user or users. The computer readable medium further includes computer instructions for collecting data pertaining to a strategic plan, analyzing the data collected, and generating customized reports regarding the progress of the strategic plan.

The foregoing and other features and advantages of the present invention will be apparent from the following more particular description of the preferred embodiments of the invention, as illustrated in the accompanying drawings.

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

### BRIEF DESCRIPTION OF THE DRAWINGS

FIG. 1 is a block diagram showing a general system architecture of one embodiment of the present invention.

FIG. 2 is a flow chart showing the overall process and control flow of one embodiment of the present invention.

FIG. 3 is a flow chart showing the updating process of one embodiment of the present invention.

FIG. 4 is a screenshot of a graphical user interface useful for logging into the system, in one embodiment of the present invention.

FIG. 5 is a screenshot of a graphical user interface useful for displaying an overview of a user's assignments and progress, in one embodiment of the present invention.

FIG. 6 is a screenshot of a graphical user interface useful for displaying status information to a manager, in one embodiment of the present invention.

FIG. 7 is a screenshot of a graphical user interface useful for providing updates, in one embodiment of the present invention.

FIG. 8 is a screenshot of a graphical user interface useful for tracking progress on an assignment, in one embodiment of the present invention.

FIG. 9 is a screenshot of a graphical user interface useful by a manager for tracking progress, in one embodiment of the present invention.

FIG. 10 is a screenshot of a graphical user interface useful for sending an update of an assignment via e-mail, in one embodiment of the present invention.

FIG. 11 is a screenshot of a graphical user interface useful for tracking and recording success factors, in one embodiment of the present invention.

FIG. 12 is a screenshot of a graphical user interface useful for displaying success factors in graphical format, in one embodiment of the present invention.

FIG. 13 is a screenshot of a graphical user interface useful for displaying financial components of the strategic plan, in one embodiment of the present invention.

FIG. 14 is a screenshot of a graphical user interface useful for displaying progress of financial components of the strategic plan, in one embodiment of the present invention.

FIG. 15 is a screenshot of a graphical user interface useful for displaying a report on a rate of completion by objectives, in one embodiment of the present invention.

FIG. 16 is a screenshot of a graphical user interface useful for displaying a report on a rate of completion by goals, in one embodiment of the present invention.

FIG. 17 is a high level block diagram showing an information processing system useful for implementing one embodiment of the present invention.

### DETAILED DESCRIPTION

Methods and systems consistent with the present invention provide a tool to better implement and track all initiatives stated in the strategic plan of a business entity. In contrast with conventional programs that are not capable of any comprehensive monitoring or assessment of progress on a company-wide scale, the present invention allows a designated user to perform project management by sending messages, communicating important outcomes, and providing both electronic and printed reports that describes the updates of the business plan. By collecting data from different sources and maintaining a paper trail associating the data with their sources, this tool may help create more accountability on the part of the users ultimately responsible for the strategic plan. Furthermore, by analyzing real-time data as it relates to a particular initiative, the present invention measures and identifies strategies that are successful and those that are not.

An embodiment of the present invention contemplates the need to maintain an institutional memory of all documents and actions associated with a strategic plan. Because strategic plans are relatively complex and may require years to implement and complete, personnel who are responsible for its completion often change over time. This turnover of personnel results in information loss, which can be detrimental to a strategic plan's implementation. By way of illustration, hospitals typically have long-term projects but a high turnover rate in the personnel responsible for achieving the goals of the projects. Frequently, people leave with critical information and no one else has knowledge of such information. By breaking the project down to assignments, tracking the assignments and keeping a log of the steps taken to accomplish each assignment, the present invention would alleviate the problems associated with high turnovers and poor documentation.

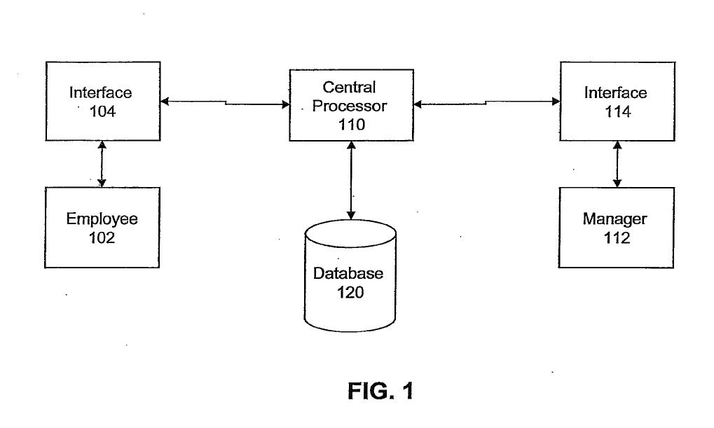

FIG. 1 is a block diagram showing the general system architecture of one embodiment of the present invention. FIG. 1 shows an interface 104 that collects data from an employee 102 that may be responsible for certain assignments that make up a strategic plan. FIG. 1 also shows an interface 114 that collects data from a manager 112 that may be responsible for certain assignments that make up a strategic plan, as well as managing duties for the strategic plan. All data collected by the interfaces 104, 114 is routed to the central processor 110 and stored in database 120.

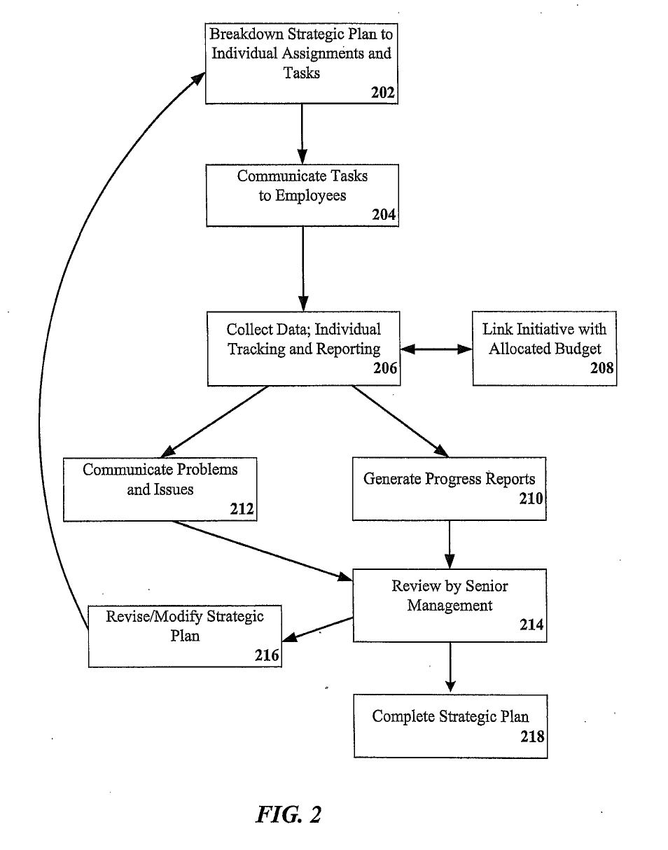

FIG. 2 is a flow chart showing the overall process and control flow of one embodiment of the present invention. In such an embodiment, a strategic plan for a business association is first broken down into measurable goals and objectives, which are converted to individual assignments and tasks in step 202. In step 204, the assignments and tasks are communicated to the appropriate users, namely the corresponding employees responsible for participating in the strategic plan. Each user, within authorized parameters, may be granted varying levels of access to the strategic plan and its components in order to become more informed and to obtain a better understanding of the big picture. Reminders may also be sent on a periodic basis to each user to prompt certain action required by goals and objectives set by the strategic plan. Such reminders may utilize “push technology,” which describes an Web-based content delivery system where information is delivered from a centralized information repository such as a central server to a client computer based on a predefined set of request parameters outlined by the client computer. The centralized repository may be configured to search for the due date of an assignment, retrieve the due date, and deliver a reminder to the user associated with the assignment. Information such as reminders and details about the strategic plan can be accessible over the Internet and is not restricted to a local network.

As the users take action on their tasks, in step 206, they may make notations of their actions and submit the status and of each task to the centralized repository. An embodiment of the centralized repository may be a centralized computer data storage system, which collects updates and communications as data from each user. According to this embodiment, the data resulting from the submissions at the centralized computer system is processed, and the actions and expenditures may be linked with an allocated budget corresponding to each task in step 208. This allows tracking of allocated operating and capital budgets and projected revenues associated with the respective tasks.

In step 210, the data is then used to generate progress reports, which may indicate the percentage of completion, the rate of completion, and the budget in conjunction with each task. Such success indicators are helpful to gauge how the strategic plan is being implemented, and whether it is ahead of schedule and within budget. The reports may also be customized to show other pertinent information relating to the specific tasks as well as the overall plan. For example, the reports may break down unfinished assignments and track these assignments back to the corresponding user or users. Maintaining a record of overdue or unfinished assignments may assist in creating accountability where the offending user can be held responsible to his or her assignment. Meanwhile, the users may communicate any problems or issues relating to each task or assignment to the senior management in step 212. At this point, in step 214, the senior management may review the reports and revise or modify the strategic plan as it deems appropriate in step 216. The changes may then be reflected in the new tasks and assignments directed to their designated users, and the process continues until all of the objectives are satisfied, including completion of the new or revised tasks. If no revision is necessary or desired, the process continues until the remaining objectives are achieved (step 218).

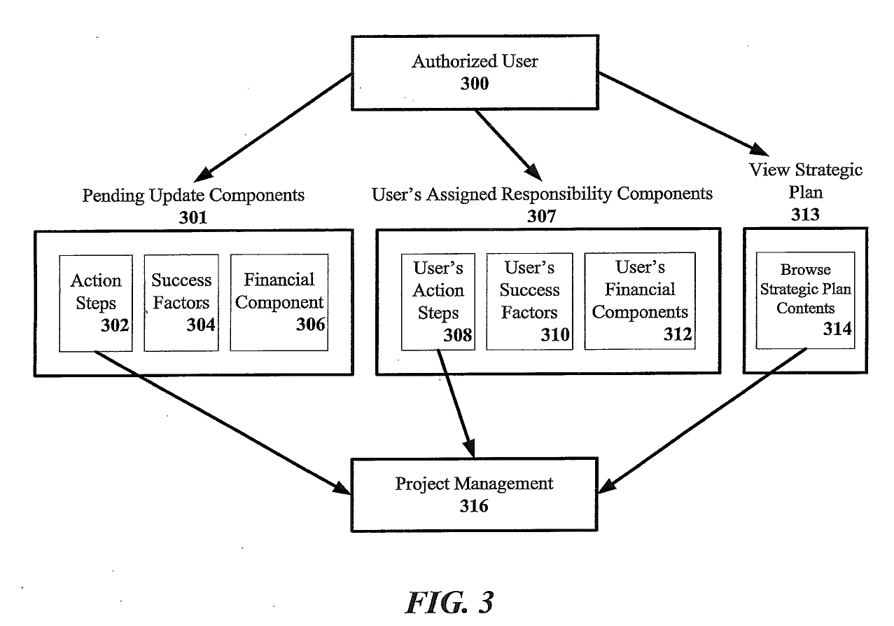

FIG. 3 is a flow chart showing the updating process of one embodiment of the present invention. Referring to FIG. 3, an authorized user 300 may choose a number of ways in which to update the strategic plan. In one embodiment, the authorized user 300 signs on and communicates with a centralized computer system through a graphical user interface, which may be individualized according to user 300 to display the pending update components 301, the user's assigned responsibility components 307 and the details of the strategic plan 313.

The individualized graphical user interface may be configured to display pending updates and due dates for user 300. Also, user 300 can send data to a centralized computer system by documenting progress as well as recording and communicating problems when there are pending updates. Examples of pending update components 301 include action steps 302, success factors 304, and financial component 306. Action steps 302 are assignments and/or tasks necessary to achieve the objective; user 300 can provide narrative updating their progress and a quantifiable status. Success factors 304 are values by which the strategic plan is to be measured. These are tangible denominations that can be tracked and measured specific to the objectives; in addition, the user may select a quantifiable status. Financial components 306 track the capital and operating budgets as well as the projected revenues.

If there are no pending assignments, user 300 can update and communicate with the centralized computer system at any time by accessing the user's assigned responsibility components 307. Under these components, the user can update progress as well as record and communicate problems at any time, without being tied to or restricted by a preset schedule. Examples of the user's assigned responsibility components 307 include user's action steps 308, user's success factors 310 and user's financial components 312. User's action steps 308 are assignments and/or task necessary to achieve the objective; the user will provide narrative updating their progress and a quantifiable status. User's success factors 310 are values by which the strategic plan is to be measured. These are tangible denominations that can be tracked and measured specific to the objectives; in addition, the user will select a quantifiable status. User's financial components 312 tracked the capital and operating budgets as well as the projected revenues.

Global users or users with rights to use the invention but do not have assigned responsibilities may look up various components of the strategic plan directly. The graphical user interface may be configured to display details of the strategic plan in step 313. According to one embodiment, the user 300 may update or communicate information by browsing contents of the strategic plan 314.

User 300 can also monitor and update the strategic plan through a project management 316 function. This option allows user 300 to further document issues, accomplishments, and recommendations pertaining to the assignment update. Here, user 300 can provide additional information to management regarding the update that resulted through the effort of the update and/or action step. This function can be performed under steps 302, 308, and 314.

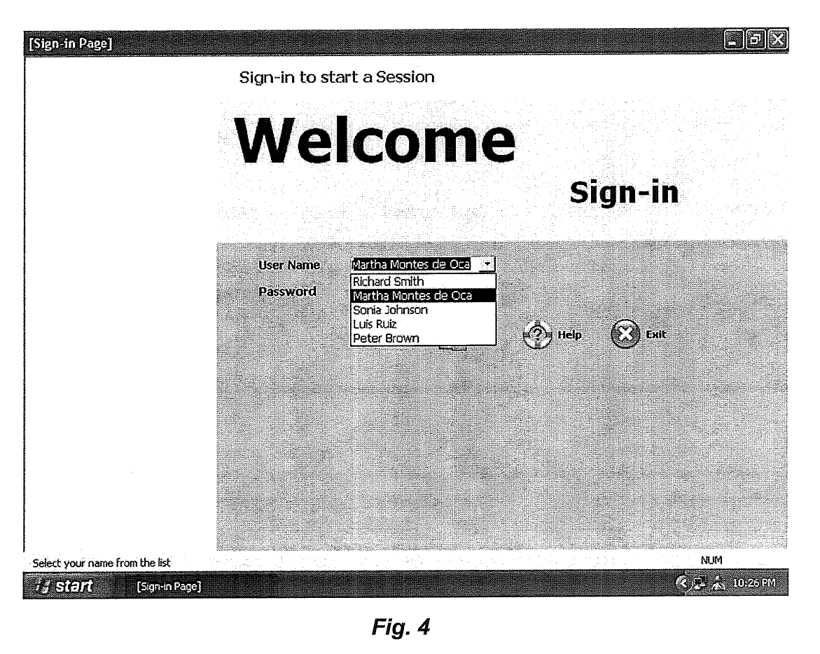

Certain aspects of the invention as shown and embodied in following screenshots may help clarify how the present invention works and how it interacts with authorized users. FIGS. 4-17 are examples of graphical interfaces through which user 300 may communicate with the centralized computer system to access and update the strategic plan.

FIG. 4 is a screenshot of a graphical user interface used for logging in, in one embodiment of the present invention. This embodiment contemplates that all users may be assigned a personal password. Types of users may include the following: Local level/minimum access; Director level/medium access; and Global level/maximum access.

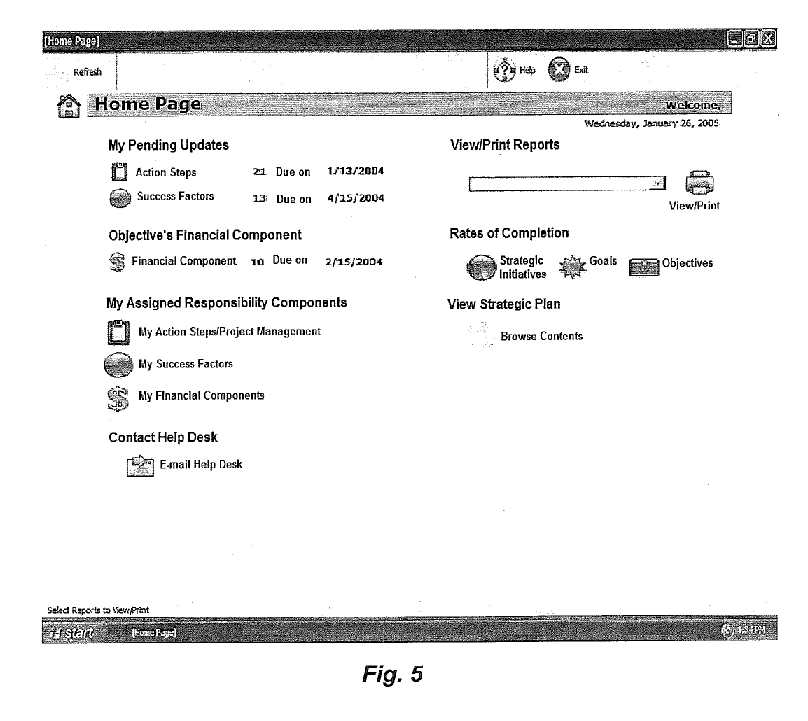

FIG. 5 is a screenshot of a graphical user interface used for displaying an overview of a user's assignments and progress, in one embodiment of the present invention. In this configuration, numerous selections detailing the status of the strategic plan are provided, such as “My Pending Updates,” “Objective's Financial Component,” “My Assigned Responsibility Components,” “Contact Help Desk,” “View/Print Reports,” “Rates of Completion,” and “View Strategic Plan.” These selections are described in more detail below. Note that they are included to illustrate the various options available to the user in relation to monitoring and updating the strategic business plan, and are not meant to be limited in the way that they are configured or described:

“My Pending Updates”: a user's pending action steps and success factors updates may be displayed in detail.

“Objective's Financial Component”: The financial component icon is where the user's pending action financial component updates are shown. This section tracks the allocated operating and capital budgets, and the projected revenues that are linked to the initiative.

“My Assigned Responsibility Components”: Lets the user update progress, record and communicate problems. The user can update the strategic plan in this section at any time.

“Contact Help Desk”: This function links the user to his or her e-mail system and he or she will be able to e-mail a message to a staff in charge of technical support.

“View/Print Reports”: Using the drop down menu, the user can select customized reports. The user can choose to view the reports on a computer screen or export them as images that may be saved as separate files or printed directly. For example, the reports may be saved as a Portable Document Format (.pdf), so that the user would not need to install any proprietary software on his or her computer in order to view the results. The Web-based features of this invention makes it easy for the user to log in anywhere and still have access to the information stored in the centralized server or repository.

“Rates of Completion”: This function generates an automatic rate of completion report. The user can choose to view the reports on a computer screen or export them as images that may be saved as separate files. The reports may also be printed directly.

“View Strategic Plan”: “Browse Contents” icon will appear only for global users. In this area the user can view and update components of the strategic plan by making selections from the drop down menus. The user can skip through and select the desired component to find an Action Step, Success Factor and Financial Component.

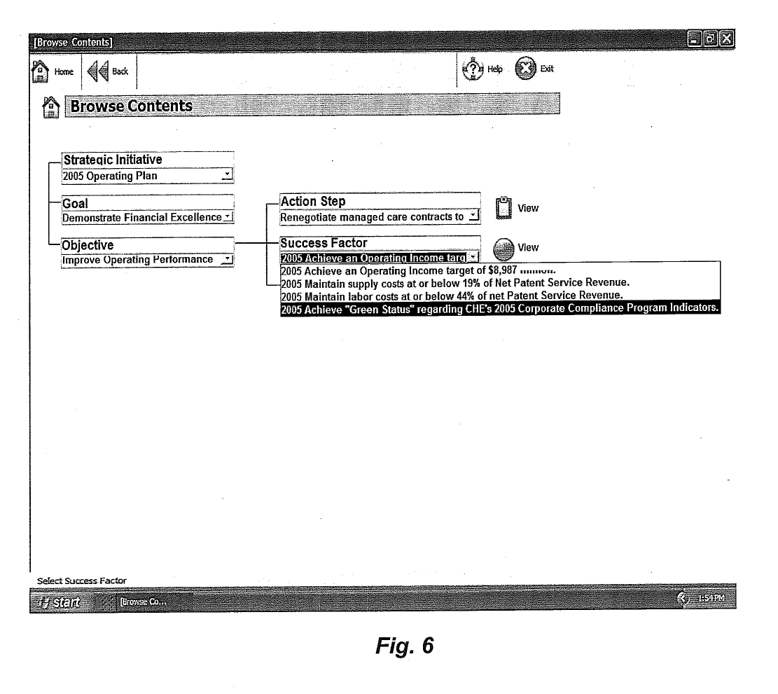

FIG. 6 is a screenshot of a graphical user interface used for displaying information to a manager, in one embodiment of the present invention. For users with rights to use the invention but do not have assigned responsibilities or are global users, the graphical user interface may be configured to display details of the strategic plan and allow the user to update or communicate information through the “Browse Contents” section to access the “View Strategic Plan” selection found in the Home Page.

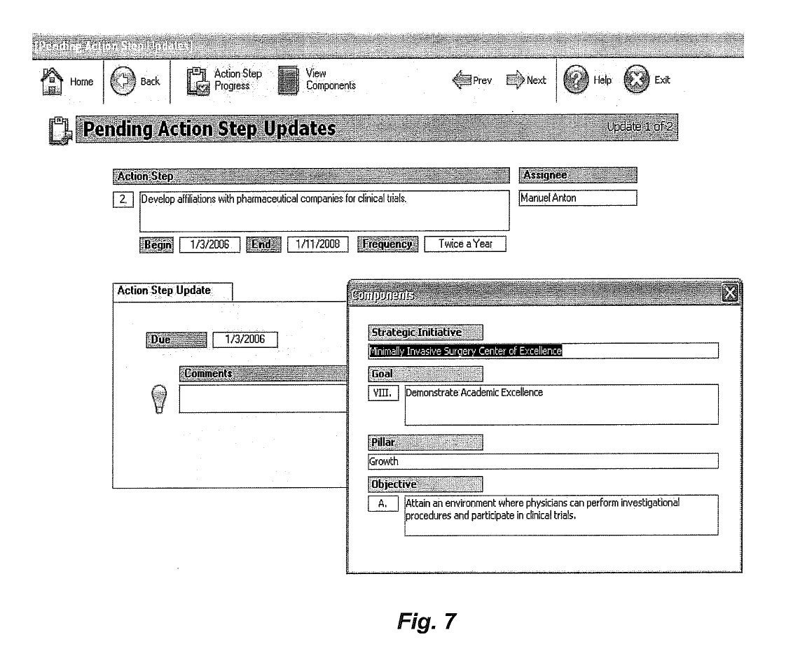

FIG. 7 is a screenshot of a graphical user interface used for providing updates, in one embodiment of the present invention. The user can update progress, record and communicate issues or problems when there are pending updates. Action Steps are assignments and/or task necessary to achieve the objective; the user will provide narrative as a way to update/record and save their progress and to provide a quantifiable status. Status can be divided into four types: On Scheduled, On Hold, Pending, and Completed.

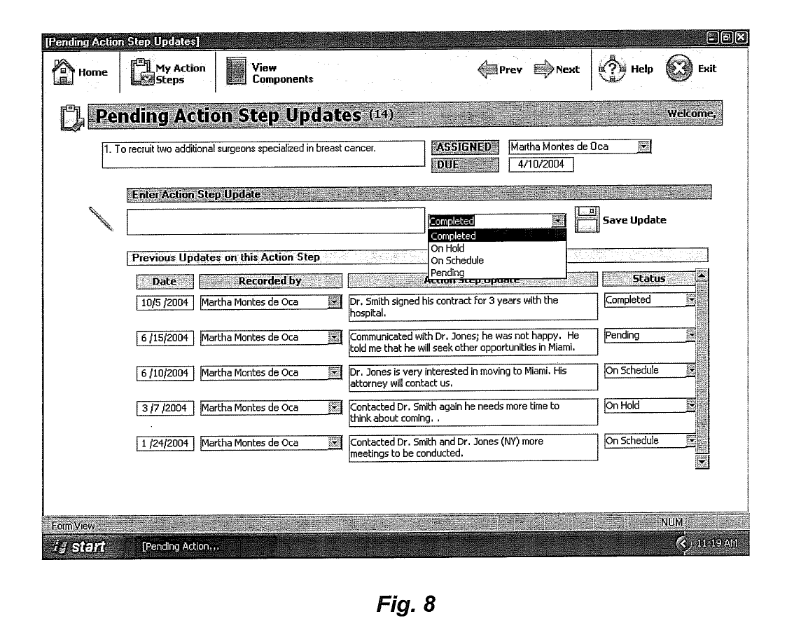

FIG. 8 is a screenshot of a graphical user interface used for tracking progress on an assignment, in one embodiment of the present invention. As continuation of FIG. 7—this figure displays the history, status, and date of all the updates provided to the assignment.

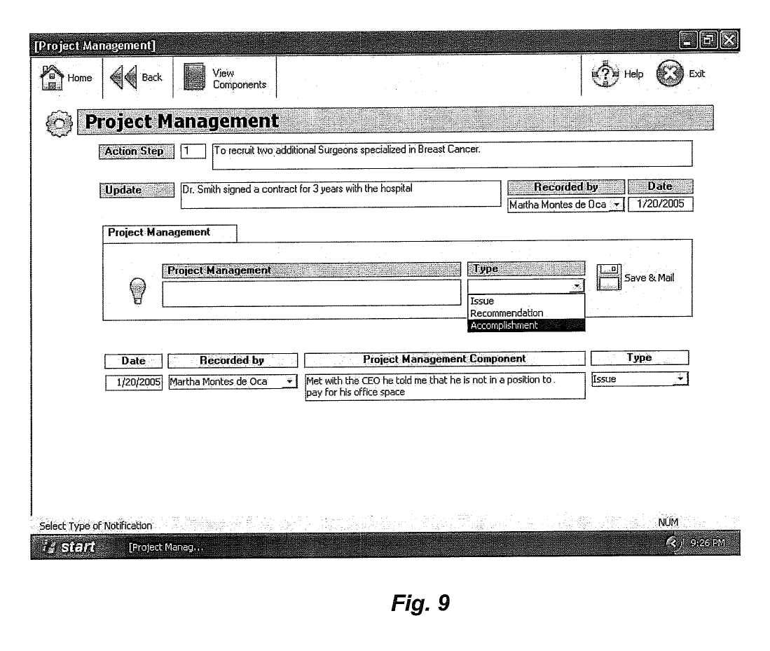

FIG. 9 is a screenshot of a graphical user interface used by a manager for tracking progress, in one embodiment of the present invention. This configuration allows the user to send information via e-mail using the Project Management function. The Project Management option is to further document issues, accomplishments, and recommendations pertaining to the assignment update. Here, the user can provide additional information to management by sending via e-mail any update that resulted through the effort of the update and/or action step. In addition, the user may provide a type of notice such as issue, accomplishment, and recommendation.

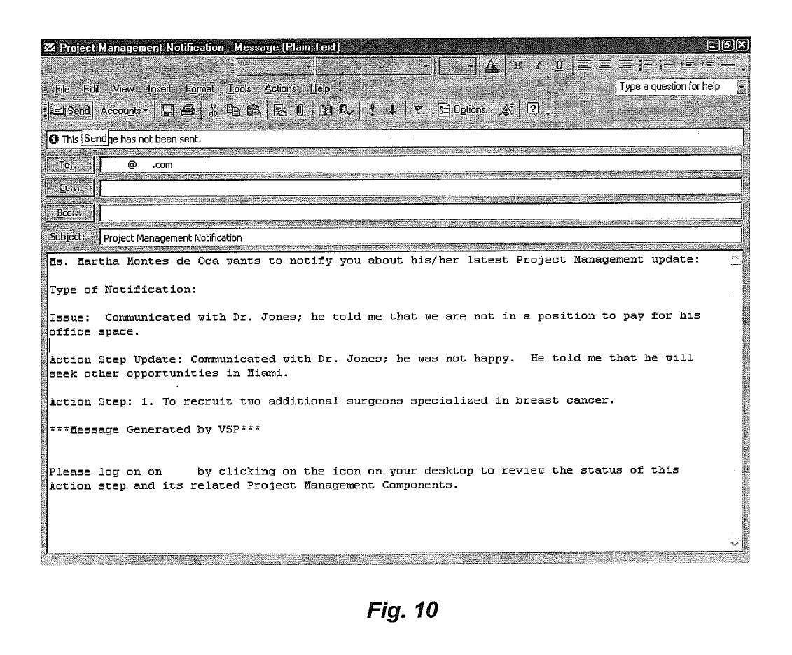

FIG. 10 is a screenshot of a graphical user interface used for sending an update of an assignment via e-mail, in one embodiment of the present invention. As continuation of FIG. 9—this configuration automatically opens an e-mail creating the e-mail instantly by pasting the necessary information directly into the e-mail so that the user only needs to type recipient's name to the e-mail.

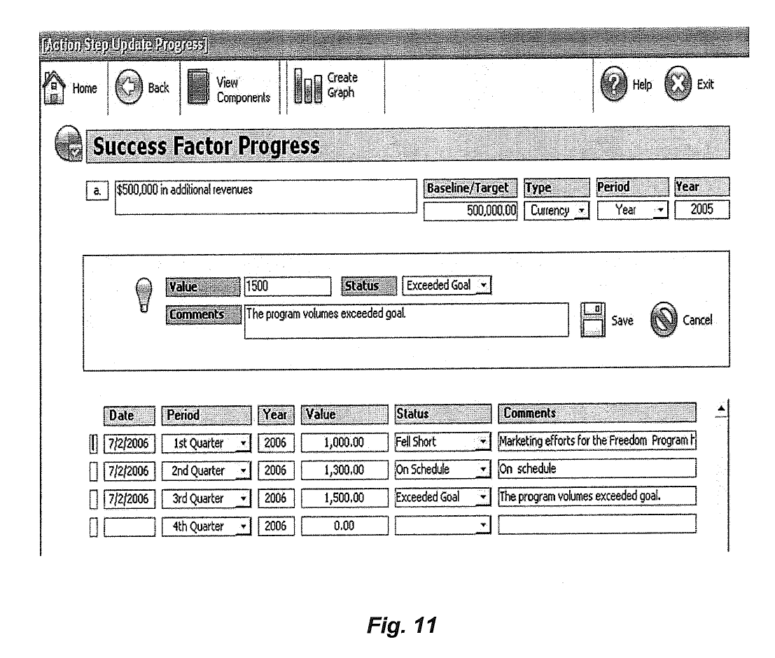

FIG. 11 is a screenshot of a graphical user interface used for tracking and recording success factors, in one embodiment of the present invention. Success Factors are values by which the strategic plan is to be measured. These are tangible denominations that can be tracked and measured specific to the objectives. In addition, the user will select a quantifiable status. This configuration has the capability to create a graph that best displays the success factors as well as expected targets by quarter.

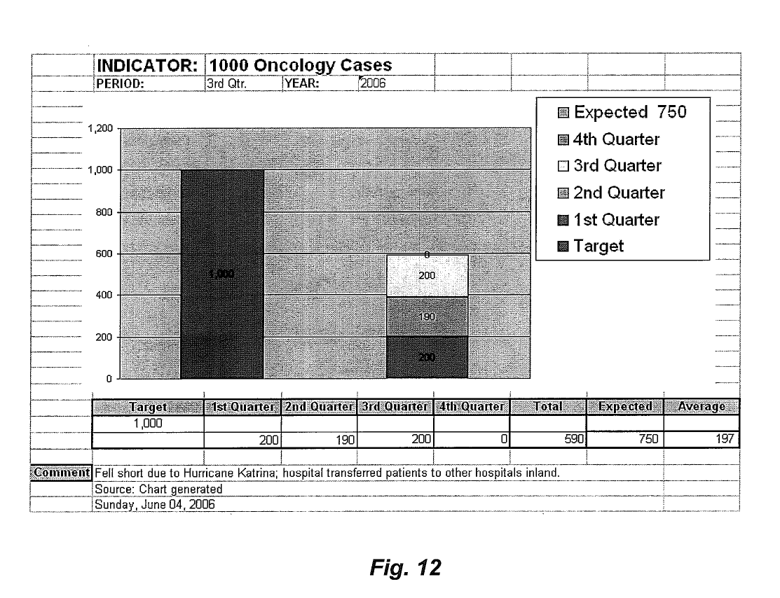

FIG. 12 is a screenshot of a graphical user interface used for displaying success factors in graphical format, in one embodiment of the present invention. A sample graph created by the present configuration is shown.

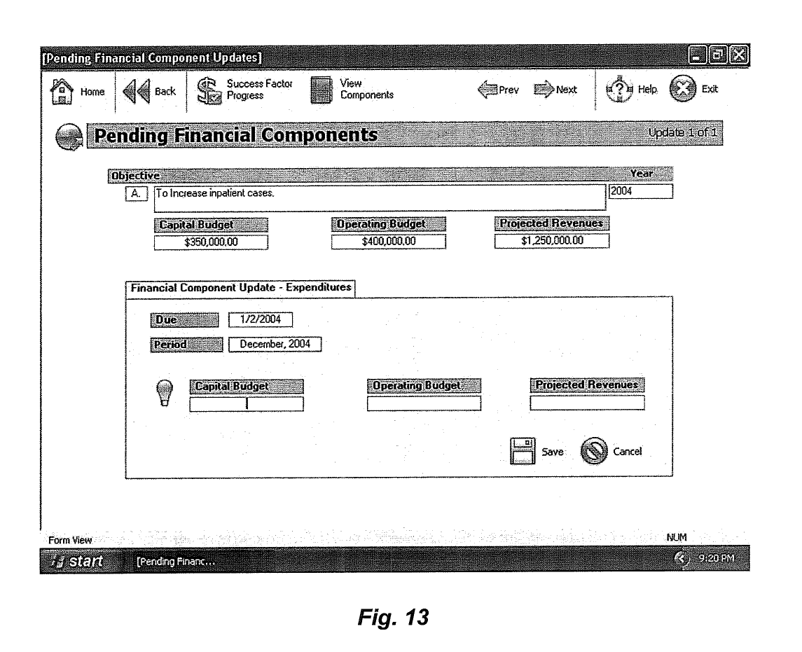

FIG. 13 is a screenshot of a graphical user interface used for displaying financial components of the strategic plan, in one embodiment of the present invention. Financial Components track the capital and operating budgets as well as the projected revenues.

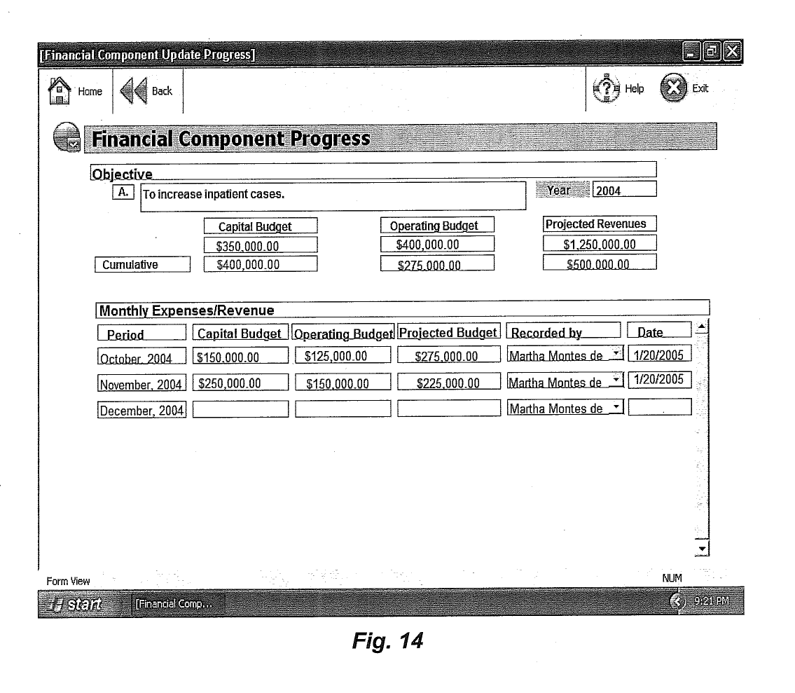

FIG. 14 is a screenshot of a graphical user interface used for displaying progress of financial components of the strategic plan, in one embodiment of the present invention. As continuation of FIG. 13—this figure displays all previous outcomes.

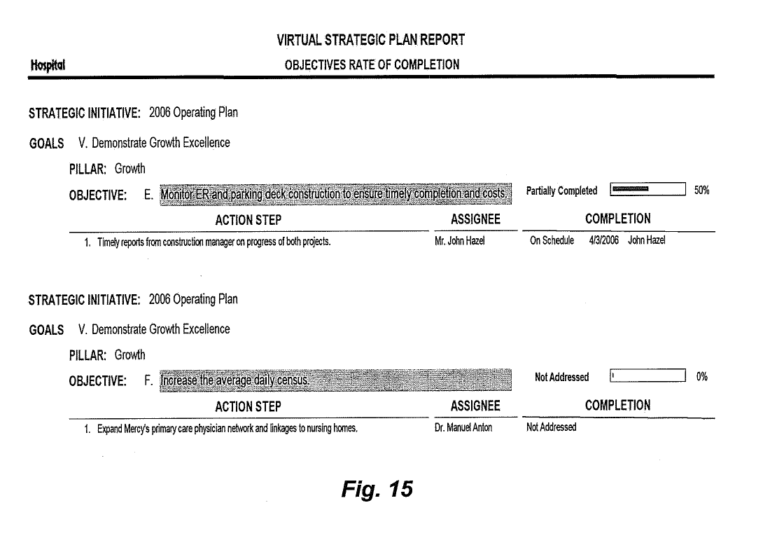

FIG. 15 is a screenshot of a graphical user interface used for displaying a report on a rate of completion by objectives, in one embodiment of the present invention. This function generates an automatic rate of completion report by objectives. The user can choose to view the reports on a computer screen or as images that may be saved as separate files. The reports may also be printed directly.

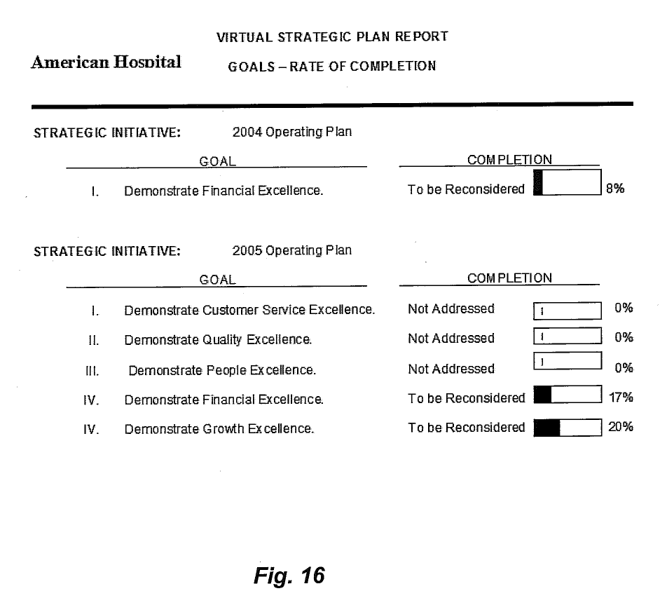

FIG. 16 is a screenshot of a graphical user interface used for displaying a report on a rate of completion by goals, in one embodiment of the present invention. This function generates an automatic rate completion report by goals. The user can choose to view the reports on a computer screen or export them as images that may be saved as separate files. The reports may also be printed directly.

The screenshots encapsulate certain aspects of the present invention to illustrate how the participants in a strategic plan may help each other toward the completion of the plan. As depicted in the various user interfaces, communications and updates from each user are collected in a centralize computer system. Such communications and updates may be made transparent to users, depending on their preset security clearances. Users may also make note of issues and obstacles, and track progress at any time. Because of the dynamic interactions between each authorized user and the integrated data located in the centralized computer system, all participants in the strategic plan are more aware of and responsive to their individual tasks and assignments. Accordingly, participation is increased, which makes the strategic plan more fluid, flexible and alive. The increased efficiency and synergy means that potential problems can be discovered earlier and resolved, and that any necessary and timely modifications to the strategic plan and assignments associated with the plan may be made.

### A Computer System for Carrying Out the Present Invention

It is to be understood that the general system architecture described in FIG. 1 may comprise various embodiments and that structural changes may be made without departing from the scope of the present invention. Going back to FIG. 1, the data collected by the interfaces 104, 114 can be text data, graphical data, voice data, or video data. Interfaces 104, 114 can be any type of computer, such as a desk top, laptop, palm top, Blackberry, or other information processing device. In one embodiment, interfaces 104, 114 are graphical user interfaces (as shown below with reference to FIGS. 4-17) that execute on a computer.

All data collected by the interfaces 104, 114 is routed to the central processor 110 and stored in data base 120. In an embodiment of the present invention, central processor 110 can comprise any commercially available computing system that can be programmed to offer the functions of the present invention. In another embodiment of the present invention, central processor 110 can comprise a client computer running a client application that interacts with the sensors as a server computer in a client-server relationship.

In an embodiment where central processor 110 and the sensors are applications or components of applications, the nodes can be implemented as hardware, software or any combination of the two. The applications or components of applications can be located in a distributed fashion in both central processor 110 and the sensors. In this embodiment, the applications or components of applications of central processor 110 and the sensors operate in a distributed computing paradigm.

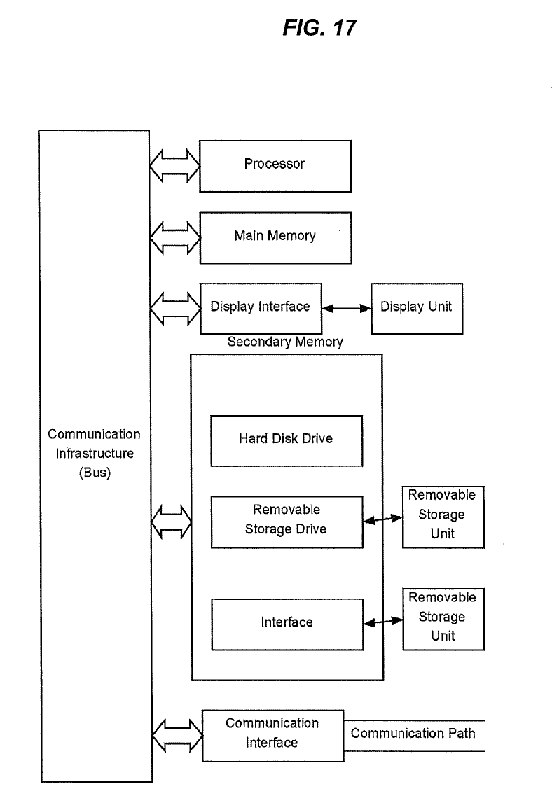

In an embodiment of the present invention, the computer systems of the central processor 110 and the interfaces 104, 114 are one or more Personal Computers (PCs) (e.g., IBM or compatible PC workstations running the Microsoft Windows operating system, Macintosh computers running the Mac OS operating system, or equivalent), Personal Digital Assistants (PDAs), hand held computers, palm top computers, smart phones, game consoles or any other information processing devices. In another embodiment, the computer systems of the central processor 110 and the interfaces 104, 114 are a server system (e.g., SUN Ultra workstations running the SunOS operating system or IBM RS/6000 workstations and servers running the AIX operating system). The computer systems of the central processor 110 and the interfaces 104, 114 are described in greater detail below with reference to FIG. 17.

In an embodiment of the present invention, a network that includes the central processor 110 and the interfaces 104, 114 is a circuit switched network, such as the Public Service Telephone Network (PSTN). In another embodiment, the network is a packet switched network. The packet switched network is a wide area network (WAN), such as the global Internet, a private WAN, a local area network (LAN), a telecommunications network or any combination of the above-mentioned networks. In yet another embodiment, the network is a wired network, a wireless network, a broadcast network or a point-to-point network. It should be noted that although central processor 110 and the interfaces 104, 114 are shown as separate entities in FIG. 1, the functions of both entities may be integrated into one entity. It should also be noted that although FIG. 1 shows only two interfaces 104, 114, the present invention supports any number of interfaces.

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following: a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer system to read such computer readable information.

FIG. 17 is a high level block diagram showing an information processing system useful for implementing one embodiment of the present invention. The computer system includes one or more processors, such as processor 1704. The processor 1704 is connected to a communication infrastructure 1702 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 1708 that forwards graphics, text, and other data from the communication infrastructure 1702 (or from a frame buffer not shown) for display on the display unit 1710. The computer system also includes a main memory 1706, preferably random access memory (RAM), and may also include a secondary memory 1712. The secondary memory 1712 may include, for example, a hard disk drive 1714 and/or a removable storage drive 1716, representing a floppy disk drive, a magnetic tape drive, an optical disk drive, etc. The removable storage drive 1716 reads from and/or writes to a removable storage unit 1718 in a manner well known to those having ordinary skill in the art. Removable storage unit 1718, represents a floppy disk, a compact disc, magnetic tape, optical disk, etc. which is read by and written to by removable storage drive 1716. As will be appreciated, the removable storage unit 1718 includes a computer readable medium having stored therein computer software and/or data.

In alternative embodiments, the secondary memory 1712 may include other similar means for allowing computer programs or other instructions to be loaded into the computer system. Such means may include, for example, a removable storage unit 1722 and an interface 1720. Examples of such may include a program cartridge and cartridge interface (such as that found in video game devices), a removable memory chip (such as an EPROM, or PROM) and associated socket, and other removable storage units 1722 and interfaces 1720 which allow software and data to be transferred from the removable storage unit 1722 to the computer system.

The computer system may also include a communications interface 1724. Communications interface 1724 allows software and data to be transferred between the computer system and external devices. Examples of communications interface 1724 may include a modem, a network interface (such as an Ethernet card), a communications port, a PCMCIA slot and card, etc. Software and data transferred via communications interface 1724 are in the form of signals which may be, for example, electronic, electromagnetic, optical, or other signals capable of being received by communications interface 1724. These signals are provided to communications interface 1724 via a communications path (i.e., channel) 1726. This channel 1726 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 1706 and secondary memory 1712, removable storage drive 1716, a hard disk installed in hard disk drive 1714, and signals. These computer program products are means for providing software to the computer system. The computer readable medium allows the computer system to read data, instructions, messages or message packets, and other computer readable information from the computer readable medium.

Computer programs (also called computer control logic) are stored in main memory 1706 and/or secondary memory 1712. Computer programs may also be received via communications interface 1724. Such computer programs, when executed, enable the computer system to perform the features of the present invention as discussed herein. In particular, the computer programs, when executed, enable the processor 1704 to perform the features of the computer system. Accordingly, such computer programs represent controllers of the computer system.

What has been shown and discussed is a highly-simplified depiction of a programmable computer apparatus. Those skilled in the art will appreciate that other low-level components and connections are required in any practical application of a computer apparatus.

According to another embodiment, computer instructions may be written with computer language such as Microsoft ASP.net using C# codes. Additionally, Microsoft SQL server may be used for out database with transact SQL codes.

An embodiment of the present invention may be implemented via an architecture framework such as an Application Service Provider (ASP). The server may be hosted locally or remotely. In addition, the interface may be Web-based, and users may interact with the invention through front end interface such as Internet Explorer or other Internet browsers.

Therefore, while there has been described what is presently considered to be the preferred embodiment, it will be understood by those skilled in the art that other modifications can be made within the spirit of the invention.

What is claimed is:

1. A computer implemented method of implementing a strategic plan comprising the steps of:
generating at least one assignment for achieving an element of a strategic plan, wherein said assignment is associated with at least one user;
presenting said assignment to said user;
collecting information pertaining to accomplishment of said assignment in a centralized repository;
analyzing said information to track progress of said assignment; and
delivering via push technology from said centralized repository to said user a reminder related to said assignment associated with said user.

2. The method of claim 1, further comprising:
generating at least one report related to achievement of said strategic plan, wherein said report is in a portable document format.

3. The method of claim 2, further comprising:
wherein said report further comprises a status report indicating a status of said assignment.

4. The method of claim 3, further comprising:
wherein said report further comprises a budget report representing a budget in connection with said assignment.

5. The method of claim 1, further comprising:
receiving from said user an update related to said assignment associated with said user.

6. The method of claim 5, further comprising:
updating a status of said assignment according to said update received from said user.

7. The method of claim 1, further comprising:
receiving from said user a communication related to assignments associated with said user; and
storing said communication in said centralized repository.

8. A computer readable medium including computer instructions for generating and tracking a strategic plan, the computer instructions including instructions for:
generating at least one assignment for achieving an element of a strategic plan, wherein said assignment is associated with at least one user;
presenting said assignment to said user
collecting information pertaining to accomplishment of said assignment in a centralized repository;
analyzing said information to track progress of said assignment; and
generating at least one report related to achievement of said strategic plan, wherein said report is in a portable document format.

9. The computer readable medium of claim 8, further comprising computer instructions including instructions for:
delivering via push technology from said centralized repository to said user a reminder related to said assignment associated with said user.

10. The computer readable medium of claim 8, further comprising computer instructions including instructions for:
wherein said report comprises a status report indicating a status of said assignment.

11. The computer readable medium of claim 8, further comprising computer instructions including instructions for:
wherein said report further comprises a budget report indicating a budget in connection with said assignment.

12. The computer readable medium of claim 8, further comprising computer instructions including instructions for:
receiving from said user an update related to said assignment associated with said user.

13. The computer readable medium of claim 12, further comprising computer instructions including instructions for:
updating a status of said assignment according to said update received from said user.

14. The computer readable medium of claim 8, further comprising computer instructions including instructions for:
receiving from said user a communication related to said assignments associated with said user; and
storing said communication in a centralized repository.

15. An information processing system for generating and tracking progress on a strategic plan, comprising:
at least one assignment for achieving an element of a strategic plan, wherein said assignment is associated with at least one user;
a first interface for presenting said assignment to said user;
a second interface for collecting information pertaining to said accomplishment of said assignment; and
a computer system configured for analyzing said information to track progress of said assignment and generating a report related to achievement of said strategic plan.

16. The information processing system of claim 15, further comprising:
a transmitter for delivering via push technology to said user a reminder related to said assignment associated with said user.

17. The information processing system of claim 15, said computer system configured for generating a report related to achievement of said strategic plan:
wherein said report comprises a status report indicating a status of said assignment.

18. The information processing system of claim 15, said computer system configured for generating a report related to achievement of said strategic plan:
wherein said report further comprises a budget report indicating a budget in connection with said assignment.

19. The information processing system of claim 15, further comprising:
a receiver for receiving from said user an update related to said assignment associated with said user.

20. The information processing system of claim 15, the processor further configured for:
updating a status of said assignment according to an update received from said user.
